(19) United States
(12) Patent Application Publication
(10) Pub. No.: US 2024/0400294 A1
(43) Pub. Date: Dec. 5, 2024

(54) Paint Marking Device with Forearm Support

(71) Applicant: FlagShooter Holdings, LLC, Garretson, SD (US)

(72) Inventor: Paul M Carrette, Garretson, SD (US)

(73) Assignee: FlagShooter Holdings, LLC, Garretson, SD (US)

(21) Appl. No.: 18/679,810

(22) Filed: May 31, 2024

Related U.S. Application Data
(60) Provisional application No. 63/470,251, filed on Jun. 1, 2023.

(51) Int. Cl. B65D 83/20

(52) U.S. Cl. CPC B65D 83/203

(57) ABSTRACT

A marking device with multiple structures that enable the user to adjust the device to make it more ergonomic. The device has an adjustable forearm support attached to a trigger grip at an adjustable wrist angle to reduce stress on the user's forearm, wrist, and trigger finger. The spray angle is adjustable and the length of the device is adjustable. The device can hold at least one can of spray paint or spray chalk, and has an engagement mechanism that moves perpendicular to the spray can valve to work with multiple configurations of spray valves. A paint deflector at the distal end of the distal paint can holster prevents overspray from building up on the actuator. The device has additional removable spray can holsters and removable flag holders. The device has multiple loops for hanging it up on a wall or attaching a carrying sling or strap.

### CROSS-REFERENCE TO RELATED APPLICATIONS

This application claims the benefit of co-pending U.S. Provisional Application No. 63/470,251 filed Jun. 1, 2023, the entirety of which is incorporated herein by reference.

### FIELD OF INVENTION

This invention relates generally to ground marking systems. This invention relates more particularly to a paint marking device with forearm support.

### BACKGROUND

Marking devices are used to mark the ground surface to indicate, for example, the presence of underground utilities, the location of lot boundaries and the like. Sometimes markers are inserted into the ground that extend upward from the ground surface and may include a flag at the top end. Sometimes the ground is marked with spray paint or spray chalk, the sprayed lines indicating the approximate location of the boundary, underground pipes, wires, or cables. Different colors may be used for each utility service, such as electric, gas, telephone, water, or sewer or different boundary lines or logos. Spray paint and spray chalk are also commonly used to mark athletic fields with boundaries and team logos.

Conventionally, when marking with spray paint or spray chalk, the spray can is attached to a long rod that has a trigger grip on its upper end and a holster on its lower end to hold the spray can upside down. The devices are known as paint sticks or marker sticks. A metal finger extends from the bottom of the holster and engages the valve on the spray can. When the trigger is pulled the valve is depressed and paint sprays out the tip of the nozzle or dip tube. The desired locations are marked by walking to the desired location, aiming, and pulling the trigger. Larger areas are painted by walking the desired distance while spraying paint.

Repetitively pulling the trigger or holding the trigger down for long periods can stress the user's forearm, wrist and trigger finger. The problem is exacerbated by having a heavy can of paint at the end of the marking device. It would be advantageous to have a marking device that reduces stress on the user's forearm, wrist and trigger finger.

### SUMMARY OF THE INVENTION

This marking device incorporates multiple structures that enable the user to adjust the device to make it more ergonomic. The device has an adjustable forearm support attached to the trigger grip at an adjustable wrist angle to reduce stress on the user's forearm, wrist, and trigger finger. In some embodiments the spray angle is adjustable and the length of the device is adjustable. The device can hold at least one can of spray paint or spray chalk, and has an engagement mechanism that moves perpendicular to the spray can valve to work with multiple configurations of spray valves. A paint deflector at the distal end of the distal paint can holster prevents overspray reflected from spraying on gravel or hard surfaces from building up on the actuator. The device has one or more additional removable spray can holsters and one or more removable flag holders. The device has multiple loops for hanging it up on a wall or attaching a carrying sling or strap.

### BRIEF DESCRIPTION OF THE DRAWINGS

FIG. 1 is a bottom perspective view of the paint marking device.

FIG. 2 is a side view of the paint marking device with three paint cans.

FIG. 3 is a side view of the paint marking device with two paint cans and a flag holder.

FIG. 4 is a side cross-section view of the paint marking device.

FIG. 5 is a close up of the trigger in callout B from FIG. 4.

FIG. 6 is a close up of the cam actuator in callout A from FIG. 4.

FIG. 7 is an end view of the paint device from the trigger end.

FIG. 8 is a cross section along line D-D of FIG. 7.

FIG. 9 is a close up of the actuator in callout C from FIG. 8.

FIG. 10 is a top view of the paint marking device with three paint cans and two flag quivers.

FIG. 11 is a bottom view of the paint marking device with three paint cans and two flag

FIG. 12 is a perspective view of the forearm and trigger portion of the paint wand.

FIG. 13 is rear close-up view of the bracket that holds the cuff in place on the rod.

FIG. 14 illustrates a user's wrist hanging at rest.

FIG. 15 shows a close-up views of the side of the pivot and the thumb screws used to set the angle of the trigger grip relative to the forearm support.

FIG. 16 is a side view of the adjustable thumb screw.

FIG. 17 shows the paint wand attached to a user's arm.

FIG. 18 is a partial end view of the distal paint can holster showing the paint deflector.

FIG. 19 is a partial cross-sectional view of the distal paint can holster showing the paint deflector and the actuator in detail.

### DETAILED DESCRIPTION OF THE INVENTION

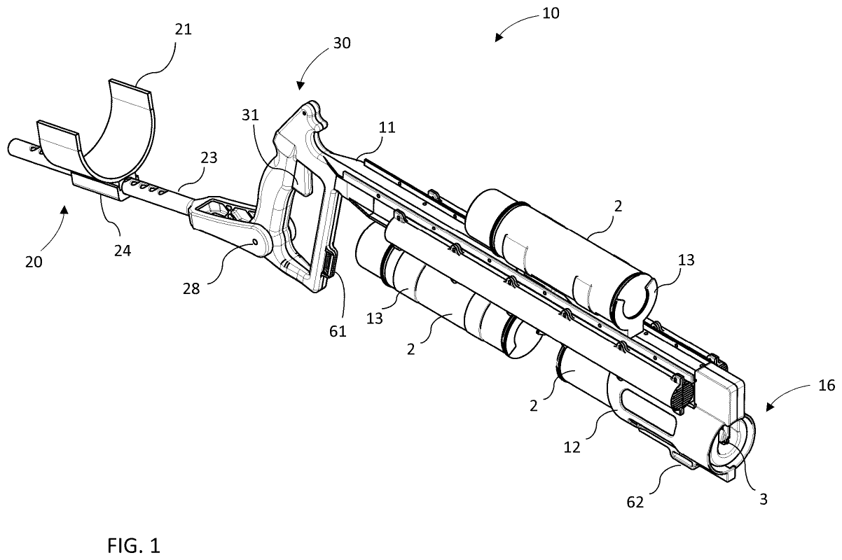

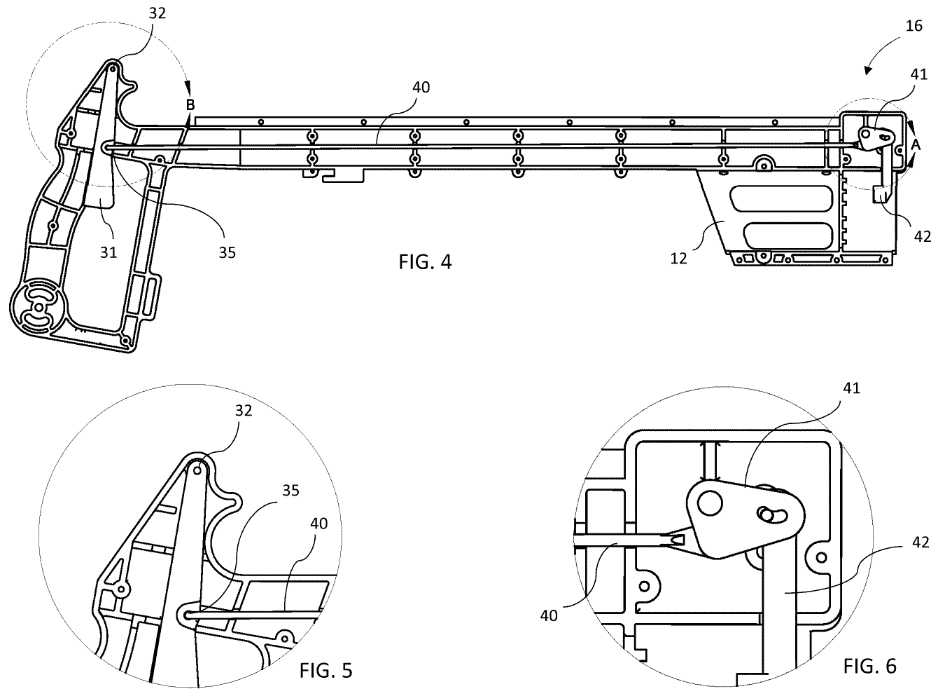

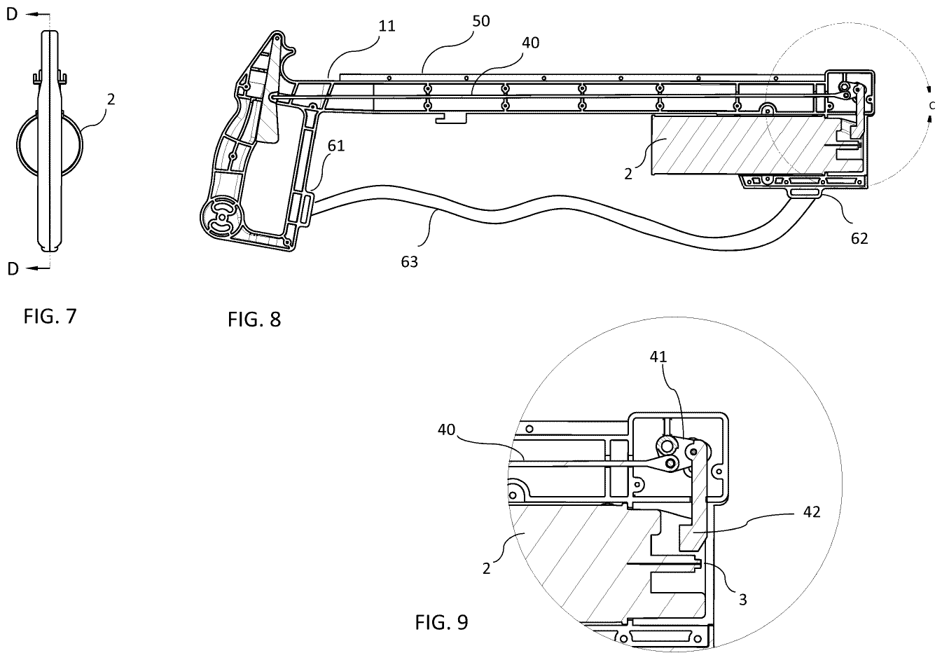

FIG. 1 is a perspective view of a paint marking device of the present invention. A forearm support 20 is pivotally attached to a trigger grip 30, which is connected to a rail 11 supporting up to three spray can holsters, and up to two adjustable flag holders 50. The active spray can 2 is held upside down in a distal can holster 12 at the distal end of the device, so that the spray valve 3 points toward the ground. In one embodiment the distal can holster 11 is permanently fixed to the rail 12. In other embodiments the distal can holster 11 is adjustably fixed to the rail 12. An engagement mechanism at the distal end of the device uses a cam assembly 41 to move an actuator 42 perpendicular to the spray can valve 3 to accommodate multiple types of spray cans. See FIGS. 4, 6, 8 and 9. The actuator 42 is configured to engage the spray valve 3 of the spray can 2 to cause the paint or chalk to be sprayed out of the spray can nozzle or dip tube.

The adjustable forearm support 20 helps minimize wrist movement, which helps eliminate stress on the wrist and associated muscle groups. The forearm support 20 braces the user's forearm against a rod 23 to take the weight off the wrist of the user. This allows the user to use stronger forearm muscles to manipulate the path of the spray can rather than relying on the relatively weaker wrist muscles. The forearm support 20 is adjustable, with a cuff 21 that slides on the rod 23 to be closer to or farther away from the trigger grip 30. The closer the cuff 21 is to the user's elbow, the more the user is able to leverage his or her arm to direct the paint. The cuff 21 is held in place on the rod 23 with a bracket 24. See FIG. 13. Preferably the bracket 22 has two halves of plastic or metal that are attached together over the rod 23 with a screw to fix the cuff 21 in place on the rod 23. Alternatively, the cuff 21 may click into place into detents, holes or slots on the rod 23 or be held in place by friction fit. The cuff 21 is also adjustable in diameter to accommodate thinner and wider forearms. An adjustable strap 22 may be used to hold the user's forearm securely in the cuff 21. See FIG. 17.

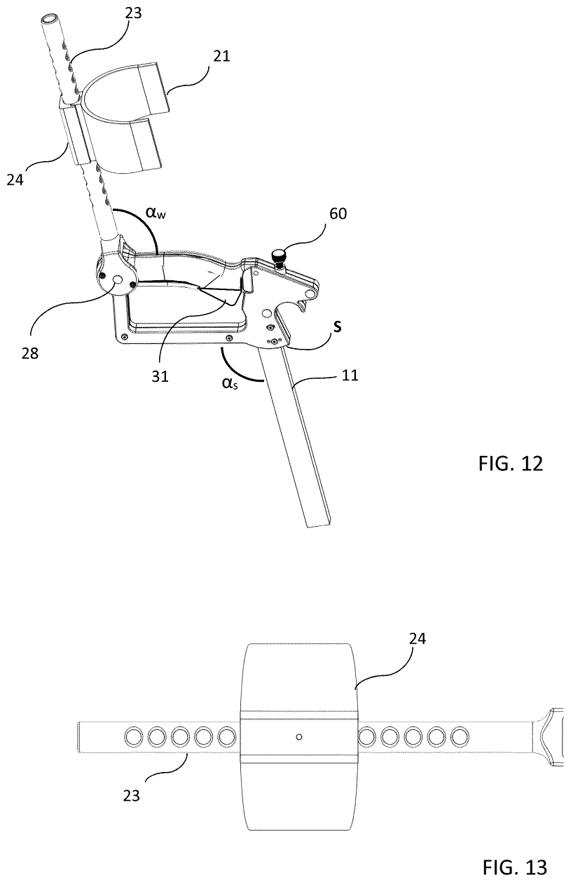

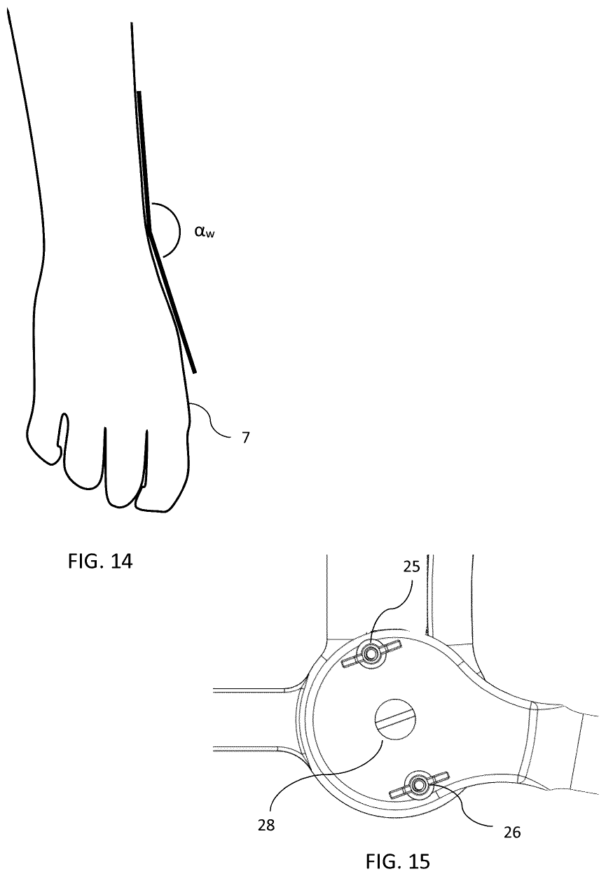

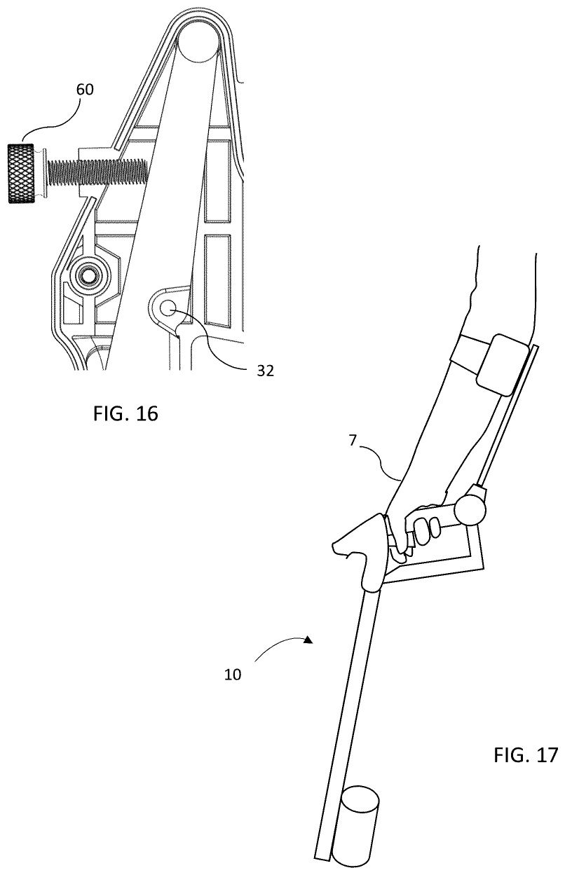

The forearm support 20 is pivotally attached to the trigger grip 30 at a center pivot pole 28 to increase leverage and decrease amount of force needed to overcome spring return pressure to activate the spray can nozzle. See FIGS. 12 and 15. The angle of the forearm support 20 relative to the trigger grip 30 affects the angle of the wrist relative to the trigger grip, and when set at the proper angle thereby helps eliminate stress on the wrist. For the wrist to be as unstressed as possible, the angle of the trigger grip 30 should be set to the user's natural wrist position. That wrist angle α_{w} is determined by observing the natural angle the user's forearm makes to the side of his or her hand. See FIG. 14, showing the user's wrist hanging at rest at wrist angle α_{w}. The angle between the forearm support 20 and the trigger grip 30 should be as close to that natural wrist angle α_{w} as possible.

The angle of the forearm support relative to the trigger grip can be set at a desired angle. In one embodiment, the wrist angle α_{w} is fixed set by a pair of thumb screws 25, 26, which permits this angle to be easily adjusted. See FIG. 15. Preferably the thumb screws have wingnuts or are knurled to make it easy to tighten and loosen them by hand for adjustability between different users. To adjust the wrist angle α_{w}, the thumb screws 25, 26 are loosened. Once loosened, the forearm support 20 can rotate about the center pivot pole 28 and be set at the wrist angle α_{w} that approximates the angle the user's forearm makes to the side of his or her hand 7. Alternatively, wrist angle may be adjustably fixed into place into detents, holes or slots near the pivot point or be held in place by friction fit. Preferably the forearm support 20 is first strapped onto the user's forearm while setting the angle of the grip relative to the hand. Once the grip feels comfortable and the user's wrist is in a natural position, the thumb screws are tightened to set the position in the user's desired location.

An adjustable spray angle can also help eliminate stress on the wrist. See FIG. 12. The spray angle αₛ is the angle of the trigger grip relative to the rail. The angle of the rail 11 is pivotably adjusted with respect to the trigger grip 30 at joint S. The spray angle may be freely adjustable, but preferably the spray angle can be set to multiple distinct positions, which improves the rigidity of the assembly. To change the spray angle, an outer thumb screw is removed completely and a second thumb screw is only loosened. The position of the rail 11 is adjusted so that the holes line up between the trigger grip 30 and the frame around it. The outer thumb screw that was removed is placed in the new hole and tightened until it is firmly in place. Then, the other thumb screw is tightened as well. The new spray angle αₛ is now set. Alternatively, the trigger grip 30 may click into place into detents, holes or slots on the rail 11 or be held in place by friction fit.

To further reduce stress on the user's hand, the trigger grip 30 includes a trigger 31 large enough for the user to use two fingers to pull the trigger 31, as opposed to the smaller triggers of paint wands of the prior art that have enough surface area for only one finger. See FIG. 17.

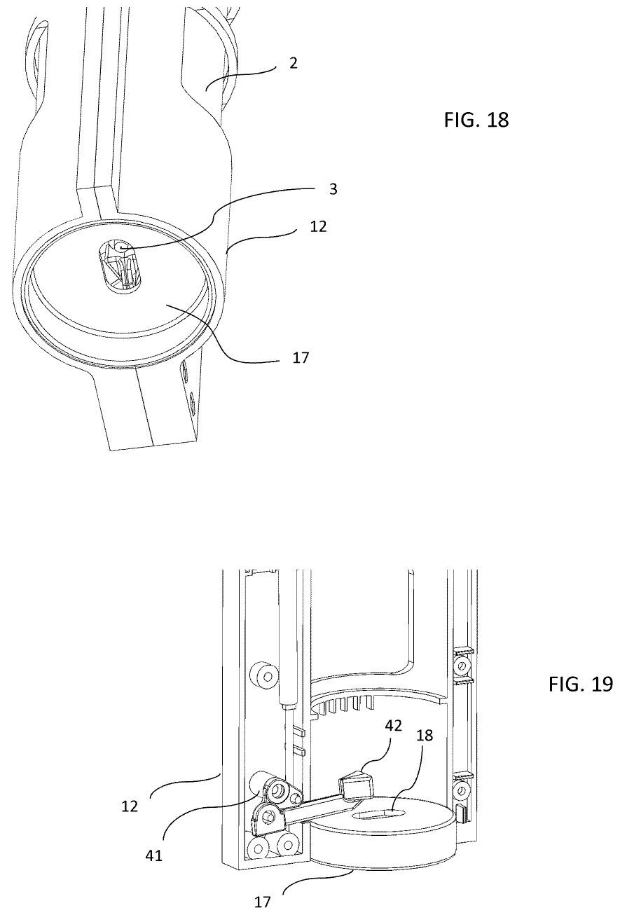

In addition, the structure of the trigger grip 30 leverages a mechanical advantage to reduce the amount of force required of the user to pull the trigger 31. See FIGS. 4, 5, 8 and 9. The trigger 31 is pivotally connected at one end 32 to the trigger grip 30. A pull rod 40 extends from the trigger 31 to the bottom of the marking device 10 to a cam assembly 41, which in turn is connected to an actuator 42 to engage a spray valve 3. See FIG. 4. The pull rod 40 is pivotally connected to the trigger 31 at a pull rod pivot point 35 such that, when the trigger 31 is pulled, the pull rod 40 is pulled toward the proximal end 15, or top, of the marking device and away from the distal end 16, or bottom, of the device. The pull rod 40 causes the cam assembly 41 to move the actuator 42 against the spray can valve 3. The pull rod pivot point 35 is at a position on the trigger 31 sufficient to move the cam assembly 41 to apply sufficient pressure to the valve 3 of the paint can 2 to cause it to spray. See FIGS. 5, 6, 8, 9 and 19. This position of the pull rod pivot point 35 finds a balance between the distance the trigger is pulled to the distance the cam assembly 41 rotates to cause the valve to spray. To prevent “overstroking” of the valve 3 and accidentally knocking the spray valve off, a thumb screw 60 located in the trigger grip 30 is used to customize the length of the stroke the actuator 42 makes when contacting the valve 3. See FIGS. 12 and 18. The thumb screw 60 can be tightened down to make contact with the trigger 31 and stop it from being drawn back too far and can be set each time a new brand or type of spray paint can is used. If so desired, the thumb screw 60 can be tightened in during travel between job sites to act as a safety to prevent accidental spray.

The distal paint can holster 12 has a paint deflector 17 at its distal end, which helps prevent overspray reflected from spraying on gravel or hard surfaces from building up on the actuator. The deflector has an aperture 18 through which the paint or chalk exits the deflector and a surrounding surface 18 that blocks overspray or paint reflected from the surface being sprayed. The deflector 17 may be integral with the distal paint can holster 12 or removable for easy cleaning.

The length of the device is adjustable to accommodate user's height, arm length, and desired angle between the distal end of the device and the ground during operation. In one embodiment the rail 11 can be telescoped between shorter and longer lengths. In another embodiment the distal paint can holster 12 can be moved up or down the rail 11 between the trigger grip and the nozzle of the spray can, changing the effective length of the device.

Additional spray cans of paint or chalk can be retained on the device using additional permanent fixed, adjustable, or removable holsters 13. The removable holsters may be configured with a clip (not shown) that lets the user clip the spray can onto a user's waist belt or belt loop or on the paint wand.

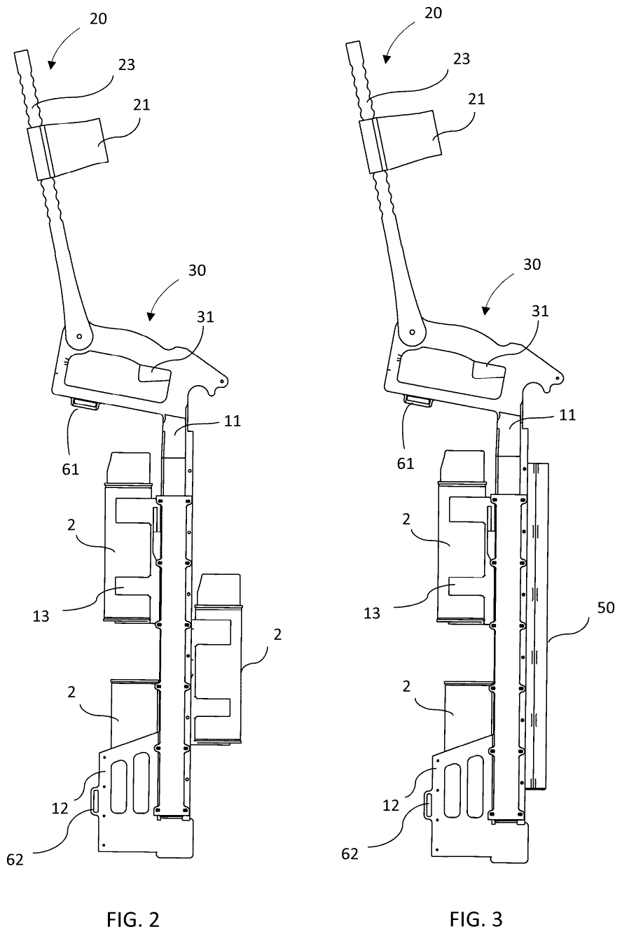

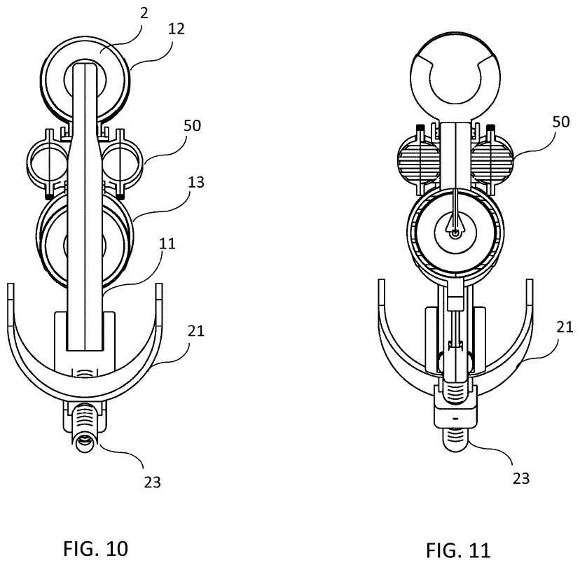

A can holster may be of any configuration that holds the can substantially parallel to the rail 11, such as c-shaped resilient bands or solid-wall cylinders, such as those as shown in FIGS. 1-3 and 10-11. Flags can be stored on the device in up to three removable flag holders 50, which are tubes, each of which is open at its top end and closed on its bottom end. See FIGS. 1, 10 and 11. The holsters 13 and flag holders 50 are removable, attaching to a rail system along the rail 11 at adjustable desired positions. This allows for different lengths of flags.

The device has multiple apertures or loops 61, 62 for hanging it up on a wall or attaching a carrying sling 63 or strap. See FIG. 8.

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims.

I claim:

1. A marker stick comprising:
a. a rail having a proximal end and a distal end;
b. a trigger grip attached to the rail at its proximal end;
c. a forearm support attached to the trigger grip;
d. a first can holster connected to the rail at its distal end, the holster configured to hold a spray can;
e. an engagement mechanism at the distal end of the rail operable by the trigger grip, the engagement mechanism configured to engage a spray valve of the spray can.

2. The marker stick of claim 2 wherein the angle of the forearm support relative to the trigger grip can be set at a desired angle.

3. The marker stick of claim 1 wherein the forearm support further comprises:
a. a rod; and
b. a cuff that is moveable along the rod to be closer to or farther away from the trigger grip.

4. The marker stick of claim 1 wherein the angle of the trigger grip relative to the rail is adjustable.

5. The marker stick of claim 4 wherein the angle of the trigger grip relative to the rail can be set at a desired angle.

6. The marker stick of claim 1 wherein the rail length is adjustable.

7. The marker stick of claim 1 wherein the length of the device between the trigger grip and the nozzle of the spray can is adjustable.

8. A marker stick comprising:
a. a rail having a proximal end and a distal end;
b. a trigger grip attached to the rail at its proximal end, the trigger grip further comprising a trigger;
c. a forearm support attached to the trigger grip;
d. a first can holster connected to the rail at its distal end, the holster configured to hold a spray can;
e. a pull rod connected to the trigger and extending to a cam assembly at the distal end of the rail, wherein the cam assembly is connected to an actuator configured to move perpendicularly to a spray valve of the spray can.

9. The marker stick of claim 9 wherein the rail length is adjustable.

10. The marker stick of claim 9 wherein the length of the device between the trigger grip and the nozzle of the spray can is adjustable.

11. The marker stick of claim 9 further comprising a paint deflector attached to the distal end of the first can holster.

12. The marker stick of claim 9 further comprising a second can holster connected to the rail between the first can holster and the trigger grip.

13. The marker stick of claim 9 further comprising a flag holder connected to the rail.

14. The marker stick of claim 9 further comprising at least one loop.

15. The marker stick of claim 15 further comprising a carrying sling connected to the at least one loop.

16. A marker stick comprising:
a. a rail having a proximal end and a distal end;
b. a trigger grip pivotably attached to the rail at its proximal end, the trigger grip further comprising a trigger;
c. a forearm support pivotably attached to the trigger grip;
d. a first can holster connected to the rail at its distal end, the holster configured to hold a spray can with its valve pointed down;
e. an actuator operable by the trigger.

17. The marker stick of claim 16 wherein the forearm support comprises:
a. a rod;
b. a cuff that is moveable along the rod to be closer to or farther away from the trigger grip; and
c. a bracket that fixes the cuff at a desired distance from the trigger grip.

18. The marker stick of claim 17 further comprises an adjustable strap that cooperates with the cuff to hold the user's forearm securely in the cuff against the rod.

19. The marker stick of claim 16 wherein the rail length is adjustable.

20. The marker stick of claim 16 wherein the length of the device between the trigger grip and the nozzle of the spray can is adjustable.
